(19) United States
(12) Patent Application Publication
(10) Pub. No.: US 2015/0377026 A1
(43) Pub. Date: Dec. 31, 2015

(54) Wheel of a Turbine, Compressor or Pump

(71) Applicant: THY ENGINEERING, Ruitz (FR)

(72) Inventor: Thierry Lefevre, Dogneville (FR)

(73) Assignee: THY ENGINEERING, Ruitz (FR)

(21) Appl. No.: 14/769,661

(22) PCT Filed: Feb. 20, 2014
(86) PCT No.: PCT/FR2014/050348

§ 371 Date: Aug. 21, 2015

(30) Foreign Application Priority Data
Feb. 21, 2013 (FR) 1351503

(51) Int. Cl. F01D 5/02; F04D 29/32

(52) U.S. Cl. CPC F01D 5/02; F04D 29/321; F05D 2220/40; F05D 2240/20; F05D 2250/26

(57) ABSTRACT

A wheel of a rotating machine for a fluid includes blades that project on the front surface thereof. On one portion of the front surface which is at least 70% of the diametrical range that defines the blade installation area, the front surface is tangential to a cone, the tip of which is pointed forward and the vertex angle of which is between 154° and 170°. A rotating machine and a turbocompressor that includes such a wheel are described.

### TECHNICAL FIELD

The present invention relates to a rotor of a rotary machine for a liquid or gaseous fluid, such as a rotor of a centrifugal compressor, centrifugal pump or centripetal turbine. It also relates to a compressor, a centrifugal pump or a centripetal turbine equipped with such a rotor, as well as a turbocompressor of which at least one of the rotors is of this type.

### PRIOR ART

Rotary machines such as centripetal turbines or centrifugal type compressors are widely used in industry, in particular in the field of heat engines. In one application, a turbine coupled on the same shaft as a compressor is used to form a turbocompressor. The turbine is supplied with exhaust gases from an engine and drives the compressor, which compresses fresh air for supercharging the engine. Certain compressors are driven by an electric motor and certain turbines are employed to generate electrical power.

FIGS. 5 and 6 show a centrifugal compressor 11 according to the prior art. The compressor 11 comprises a compressor body 111 and a rotating part rotatably mounted on the compressor body 111. The rotating portion comprises a compressor rotor 112 mounted on a shaft 114 rotating on a bearing 113 of the compressor body 111. The compressor rotor 112 includes a hub 1120 and a set of blades 1121 fixed to the hub. The body of the compressor 111 comprises an axial opening placed facing the hub 1120 constituting an inlet duct 1110. The body of the compressor 111 further includes a volute 1112 around the compressor rotor 112. The volute 1112 comprises a peripheral opening 1111 placed on the periphery of the compressor rotor 112 and leads into an outlet duct 1113 which extends substantially in a direction tangential to the compressor rotor 112. A gaseous fluid circulates from the axial opening 1110 to the peripheral opening 1111 while being driven by the compressor rotor 112. The geometry of the blades 1121 is designed so that the compressor rotor 112 supplies mechanical energy to the gases, this mainly by accelerating them, the kinetic energy thus obtained being then converted into pressure, mainly in the volute 1112.

A centripetal turbine has a structure rather similar to that of a centrifugal compressor previously described, but the direction of circulation of the gases is inverted and work is provided to the machine by the fluid. In the case of a turbine with a gaseous fluid, the geometry of the blades is designed so that the gases expand passing through the rotor of the turbine and provide energy to it.

The configurations known conventionally for working with a gaseous fluid operate at very high rotation speeds, on the order of 200,000 revolutions per minute. The technology used to allow such speeds to be attained is very specific, particularly with regard to bearings which can only be hydrostatic and are therefore required to be supplied with lubricant under pressure by a pump. In addition, such speeds cannot be currently attained when the compressor rotor is driven by an electric motor.

However, the automobile industry has seen develop a strong tendency to reduce displacement for the more general purpose of reducing fuel consumption levels, which caused the emergence of the necessity to develop, particularly for supercharging, rotary machines which are efficient at low engine power and thus for low gas flow rates.

A considerable augmentation in pressure is obtained by centrifugal rotary machines when the fluid is liquid. These machines are called pumps, which are generally distinguished by large-diameter rotors including plane flanges on which the blades are installed. Such machines are limited in their speed of rotation due to the diameter of the rotors, involving high centrifugal forces.

The invention therefore aims to supply a rotor for a rotary machine which makes it possible to attain high efficiency for a low fluid flow rate.

### DESCRIPTION OF THE INVENTION

Considering these purposes, the invention has as its object a rotor for a rotary machine for a fluid, the rotor having an axis of the rotor and comprising a hub arranged for mounting the rotary rotor about the axis of the rotor, a flange fixed to the hub and extending substantially in a radial plane with respect to the axis of the rotor, the flange comprising a front face, blades extending from the front face, each of the blades extending at most between a central circle and a peripheral circle located on the front face, at least one blade extending to the central circle and one blade at least extending to the peripheral circle, characterized in that an inner circle and an outer circle located on the front face between the central circle and the peripheral circle have a difference in diameter of at least 70% of the differences in diameters between the central circle and the peripheral circle, the inner and outer circles belonging to a first circular cone of which the apex is oriented forward and of which the apex angle is comprised between 154° and 170°, and in that a second cone having as its axis of revolution the axis of the rotor, and the apex whereof is oriented forward, tangent to the front face in any circle comprised between the inner and outer circles, has an apex angle less than or equal to 170°.

When a rotary machine is called upon to operate at a low fluid flow rate, a set of constraints induces constituting a circulation of fluid extending substantially in a radial plane and having a relatively low axial component. For a compressor or a centrifugal pump, the work supplied to the fluid is proportional to the product of the speed of rotation and the difference between the inlet and outlet radii of the blading. It is therefore necessary to use rotors allowing radial circulation of the fluid over a great length. This is the case more generally for all rotary machines which must have good performance at low flow rates.

Thus, for a compressor, the trailing edges of the blades will be placed at a large diameter while the leading edges must be located as closely as possible to the axis of rotation of the rotor. However, increasing the outlet diameter of the blading tends to increase the output area because the height of the blades can only be reduced to a limited degree except by inducing considerable losses, due to the fact that the clearance between the blades and the body of the compressor would cease to be much smaller than the height of the blades.

Moreover, due to the conservation of flow through each cylindrical section of the flow path, an increase of the outlet cross-section involves in return an increase of the inlet cross-section of the fluid into the blading. We observe, however, that for compressor rotors representing the immense majority of rotors designed according to the prior art, this constraint proves to be very antagonistic to that, previously mentioned, which encourages pushing the leading edges as close as possible to the axis of rotation of the rotor: indeed, on these rotors, the leading edges extend substantially in a radial direction, the circulation of air at the inlet of the blading having a zero or very low radial component.

On the other hand, it is observed that the antagonism mentioned here disappears if the leading edges extend in a direction near that of the axis of the rotor: one can then have leading edges located near the axis of the rotor but long enough to offer a sufficient inlet cross-section. In this case, the circulation of air extends substantially in a radial plane as soon as it arrives in the blading and, as a result, in the entire flow path. Here we are calling “radial” a rotor of a rotary machine, the geometry whereof thus constitutes a circulation of the fluid extending substantially in a radial plane and having a relatively low axial component.

The same reasoning is applicable in the case of a centrifugal pump. In the case of a centripetal turbine, it can also be beneficial to employ a radial type rotor, even though the reasoning given previously, valid for the compressor or the centrifugal pump, is only partially transposable to the turbine. Indeed, if the turbine rotor must operate at a low gas flow rate, it is not necessary that the flow path be high at the exit. On the contrary, it is actually advantageous that it not be to an exaggerated extent because this would lead to uselessly weighing down the turbine, the work supplied by the fluid on the inner part of the blading counting only for a small part of all of it. In any case, it is not necessary, from the point of view of fluid mechanics, to place the trailing edges in a direction near that of the axis of the rotor. It is therefore possible to have a turbine rotor similar to a radial type rotor for the most part, but having a semi-axial or fully axial fluid exit.

In any case, we are considering here a rotor for which the circulation of fluid extends substantially in a radial plane over a very large majority of the surface of the flange.

One of the aspects limiting the rotation speed of a radial type rotor is the mechanical constraint generated by the installation of blades on the flange. This constraint comes primarily from the fact that the centrifugal forces applied to the blades shifted forward tend to deform the flange rearward and thus to stretch the front face. This phenomenon, however, is very strongly aggravated, locally, by the concentration of forces at the root of the leading edges (for a compressor or pump rotor) or trailing edges (respectively for a turbine rotor) which are located toward the transition area between the hub and the flange, a configuration which is typically observed in the case of a radial type rotor. This mechanical constraint also results from the moment generated at the root of the blade due to the shifting thereof with respect to the front face of the flange. Finally it is necessary to note that, in the case of a radial rotor, the constraint area designated here is typically the area of the rotor which is the most heavily loaded in fatigue.

However, it is noted that, if the flange is generally given the shape of a cone of which the apex is oriented toward the front of the rotor, the centrifugal forces applied to the flange tend to straighten the flange forward, compressing its forward face, which compensates entirely or partially the stretching effect described previously. Moreover, due to this inclination of the flange, the axial shifting of the blades with respect to the flange, and hence the associated bending moment, are reduced compared to the case of a plane flange. This configuration makes it possible to drive back the rotation speed limits of the rotor or to enlarge the rotor, and therefore to obtain better performance.

Such a geometric arrangement, if it is primarily aimed at reducing the mechanical constraints in the more sensitive areas, can also be considered to optimize the deformation of the rotor. This secondary objective can aim in particular to guarantee a sufficient clearance with respect to the body of the rotating machine with regard to machining and assembly tolerances, thermal deformations, movements at bearings and vibratory deformations. In this particular case, contrary to what was explained above, the aim is to choose an angle at the apex of the cone that is slightly larger than that offering the best resistance to fatigue of the rotor.

In rotors conforming to the invention, the major part of the front face extends substantially along a cone of which the apex is oriented forward and of which the apex angle is comprised between 154 and 170°, but it is very frequent that the peripheral circle and the central circle, circles delimiting the installation areas of the blading, are located outside this characteristic area. Indeed, the profile of the front face is generally straightened on the periphery so as to orient the exit speed of the fluid in a radial plane. Moreover, due to the hub generally being thicker than the flange in the axial direction, the portion of the front face near the axis of the rotor generally has the shape of a fillet, constituting the contour of the hub; but due to the necessity of maximizing the length of the fluid circulation in the radial direction, it is frequent that installation of the leading edges (in the case of the compressor or of the centrifugal pump) or of the trailing edges (in the case of the turbine) is located in this area, and this even if the leading (respectively trailing) edges extend in a direction near that of the axis of the rotor. Besides these two portions, that is between the inner and outer circles, which represent nearly always more than 70% of the extent of the front face, the applicant has noted that it is particularly advantageous to incline the profile of the front face in the specified range. Finally, in certain configurations, the front face of the flange can be slightly curved over a very large part of the rotor, never taking on the exact shape of a circular cone section.

As a whole, very satisfactory results are obtained when the front face of the flange substantially forms a cone the apex angle whereof is comprised between 160° and 166°. It is then possible to use this configuration to confer very good performance to a rotary machine operating at a very low fluid flow rate.

It is possible, taking into account the two contradictory effects describe above, to seek the configuration that makes it possible to minimize the fatigue loading in the areas concerned. The equilibrium thus defined depends on the different geometric characteristics of the rotor, and particularly on the height of the blades, but we were able to observe that it is rather insensitive, in most of the cases considered, and that minimization of the quasi-static constraint is achieved when the front face of the flange forms substantially a cone with an apex angle near 164°. However, a slightly smaller angle makes it possible to obtain even more compression in the identified areas, and can thus sometimes constitute a better selection for resisting fatigue.

According to one particular embodiment, certain blades of a fractional sub-assembly extend from an intermediary circle comprised between the central circle and the peripheral circle. Such blades, also called “splitters,” subdivide the space between the blades that extend from the central circle. The invention is especially advantageous in such a configuration, because the leading edges (in the case of a compressor or of a pump) or the trailing edges (in the case of a turbine, respectively) of these intermediate blades are typically situated, on a radial rotor, in the transition area between the flange and the hub, that is in an area wherein the bending deformation of the flange tends to be concentrated.

In these particular cases, the inner circle and the outer circle have a difference in diameters of at least 85% of the difference in diameter between the central circle and the peripheral circle.

In one particular arrangement, the flange and the hub are integral.

The invention also has as its object a turbine, characterized in that it comprises a rotor as described previously.

The invention also has as its object a compressor, characterized in that it includes a rotor as described previously.

The invention also has as its object a turbocompressor including a turbine and a compressor, the turbine and the compressor each including at least one rotor, the rotors being rotatably coupled, characterized in that one of the rotors at least is a rotor as described previously.

### BRIEF DESCRIPTION OF THE FIGURES

The invention will be better understood and other features and advantages will appear upon reading the description hereafter, the description referring to the appended drawings wherein:

FIG. 1 is a perspective view of a rotor conforming to a first embodiment of the invention;

FIG. 2 is a section view of the rotor of FIG. 1;

FIG. 3 is a view similar to FIG. 2 of a rotor according to a second embodiment of the invention;

FIG. 4 is a section view of a turbocompressor including two rotors conforming to the invention;

FIG. 5 is a longitudinal section view on line V-V of FIG. 6 of a centrifugal compressor according to the prior art;

FIG. 6 is a section view along line VI-VI of FIG. 5;

FIGS. 7 to 10 are views similar to FIG. 2 of rotors according to the prior art.

### DETAILED DESCRIPTION

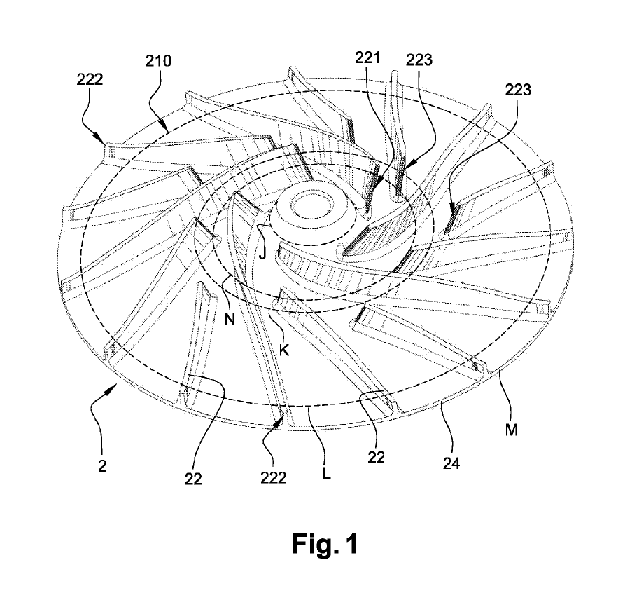

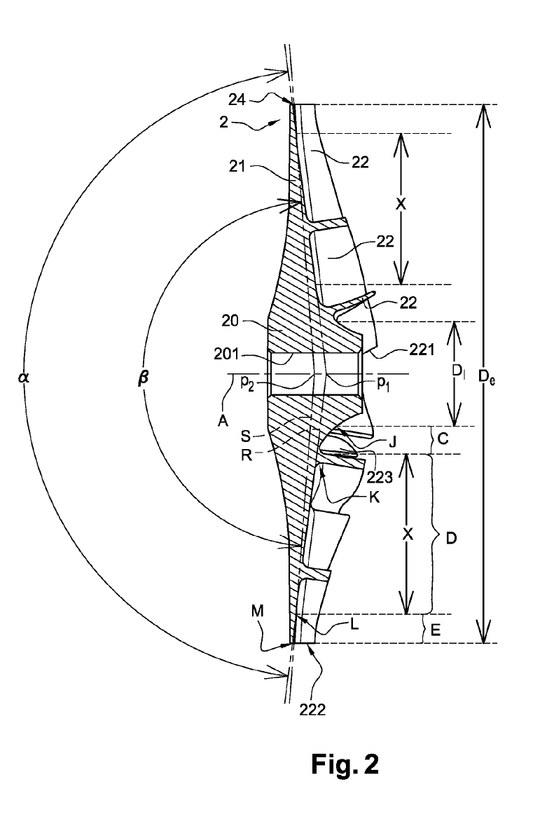

A rotor 2 of a rotary machine conforming to a first embodiment is shown in FIGS. 1 and 2. The rotor 2, that of a compressor for example, includes a hub 20 arranged to mount the rotating rotor about an axis of the rotor A, a flange 21 integral with the hub 20 and extending substantially in a plane perpendicular to the axis of the rotor A, and blades 22 mounted on a front face 210 of the flange 21 so as to protrude on a front side of the rotor 2. To be rotatably mounted, the rotor 2 includes at the hub 20 a bore 201 intended to receive a shaft, not shown. All the elements of the rotor 2 are integral, the rotor 2 being made for example by casting a metallic alloy or a synthetic material, or by machining a block of such material.

The flange 21, as seen in section in FIG. 2, has a greater width near the hub 20 than at its periphery, for reasons of mechanical strength and so as to minimize the overall deformation of the rotor. The blades 22 have the shape of a knife blade, with substantially constant thickness, and substantially perpendicular to the front face 210. Certain blades 22 extend from a leading edge 221, the base whereof is located on a circle J, near the hub 20, up to a trailing edge 222 located at the periphery 24 of the rotor 2 on the front face 210. Other blades 22 of a fractional subset, interspersed between those of the foregoing group, have a leading edge 223 located on or beyond a circle N with an intermediate diameter placed between the circle J and the periphery 24. The leading edges 221, 223 are substantially parallel to the axis of the rotor A.

The front face 210 comprises a first area C with the shape of a rounded connecting fillet which extends from the central circle J, passing through the roots of the leading edges 221, to the intersection of the leading edges 221 and the front face 210, up to an inner circle K, followed by a second area D of a substantially conical shape extending from an inner circle K to the outer circle L, then through a third area E extending from the outer circle L to a peripheral circle M to the periphery 24 of the rotor 2, the generator of the front face 210 at this outer area E being of rounded shape and tangent to the perpendicular to the axis of the rotor A at the periphery 24. In this rotor, referring in particular to FIG. 2, the diameter of the central circle represents 18.5% of the diameter of the peripheral circle. The outer circle L is defined in the present case as being the circle to which a second cone S with an angle β=170° at the apex P2 is tangent to the front face 210. The diameters of the inner circle K and of the outer circle L represent respectively 29% and 90.5% of the diameter of the peripheral circle M. The angle a at the apex of the first cone R which contains the inner and outer circles K and L is 164°. In other words, in the second area D, the angle comprised between a generator of the first cone R and a radial plane is 8°. Thus, the gap in diameter between the inner and outer circles K and L represents 74% of the diameter gap between the peripheral circle M and the central circle J. Any cone tangent to the front face 210 in any circle situated, on the front face 210, between the inner circle K and the outer circle L has an apex angle less than or equal to 170°.

The rotor conforming to the invention, and the geometric characteristics whereof are listed earlier, has been compared to a rotor that is identical aside from the fact that it includes a front face that is flat from the inner circle. In the case of these two rotors, the point of critical constraint being located at the base of the leading edge of the interspersed blade with an intermediate length, therefore relatively far from the hub, the gain provided by the balancing associated with the optimal inclination of the flange of the rotor according to the invention is very considerable. Here, optimization of the inclination of the flange, obtained with the features described previously, made it possible to obtain a reduction of almost 55% of the load at the critical point, in other words to increase by about 50% of the maximum speed of the fatigue mission profile of the compressor.

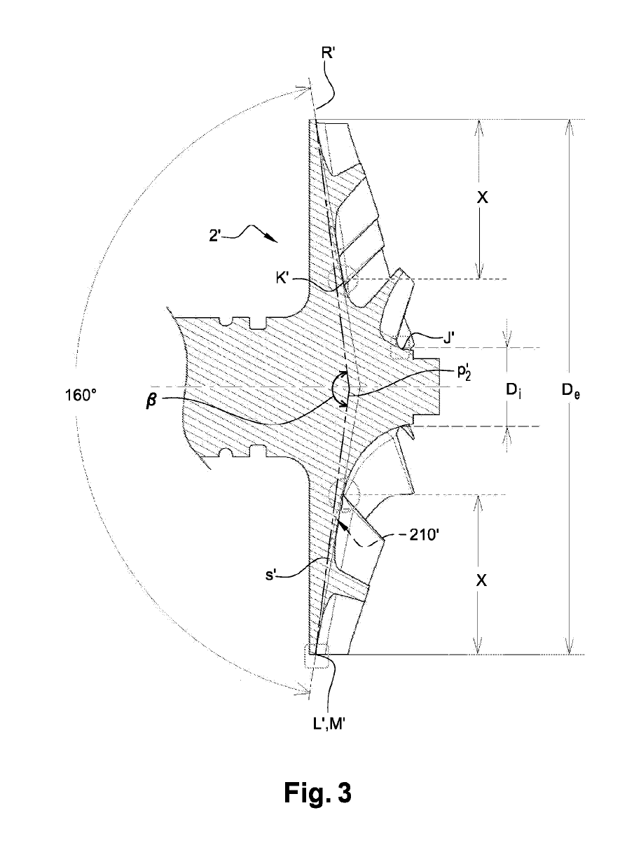

According to a second embodiment of the invention, a rotor of a centripetal turbine 2′, like that shown in FIG. 3, the front face 210′ has a profile that changes continuously between the central circle J′ with diameter Di, and the peripheral circle M′ with diameter De. The outer circle L′ is defined as coinciding with the peripheral circle M′ and the inner circle K′ with diameter (De-2X), where

$$X = 0 , 7 \frac{De - Di}{2} .$$

The first cone R′, containing the inner circle K′ and outer circle L′, has an apex angle of 160°. The more open second cone S′ is the cone with the greater apex angle which is tangent to the front face 210′ between the inner and outer circles K′ and L′. In this configuration, the second cone is tangent to the front face 210′ at the outer circle L′. The angle β at the apex P2′ of the second cone S′ is 166°.

A set of elementary conditions makes it possible to characterize certain geometric traits belonging to the invention and to distinguish it from the prior art. It is observed first of all that, for centrifugal compressors or centripetal turbine rotors other than those, rarely, of the radial type, the curve generating the front face has always, by construction, the shape of one-quarter of an ellipse. This is the consequence of a triple geometric condition: first, the direction of the outlet of gases on the centrifugal compressor or pump and those of the inlet of gases respectively into the centripetal turbine are by definition substantially radial; secondly, the circular symmetry associated with the rotating character of the system as well as the necessity of positioning together the various circulation channels of the fluid imply that the direction of inlet of the gases into the centrifugal compressor or pump, and that of the outlet of gases respectively in the centripetal turbine are always axial;

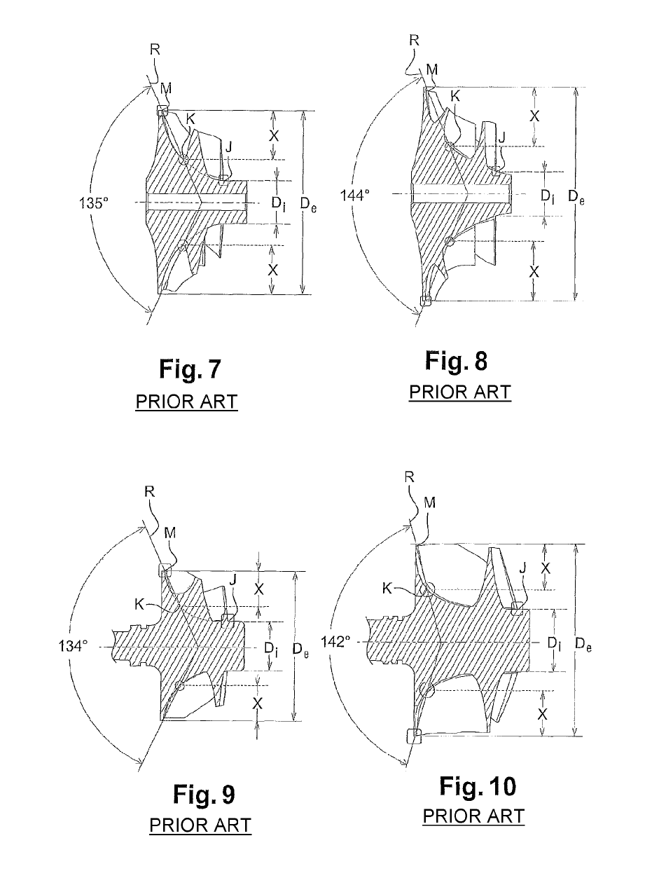

third, for better efficiency, the aim is to avoid too strong a curvature of the flow path. More commonly, this shape is rather close to a quarter of a circle. FIGS. 7 to 10 show compressor and turbine rotors according to extremely common design. The blades extend as a whole from a central circle J to a peripheral circle M. For each of these rotors respectively, two circles K and L, inner and outer, are considered to be located on the front face between the central circle J and the peripheral circle M, the difference 2X in diameter between the outer circle L and the inner circle K being equal to 70% of the difference (De-Di) in diameter between the peripheral circle M and the central circle J, the positions of circles K and L being such, moreover, that the apex angle of a first cone R running through these two circles is a maximum. In each of these configurations, the outer circle L coincides with the peripheral circle M.

It is observed that the apex angle of the first cone R thus constructed is typically comprised between 130° and 145°, in other words outside the angular range characteristic of the invention.

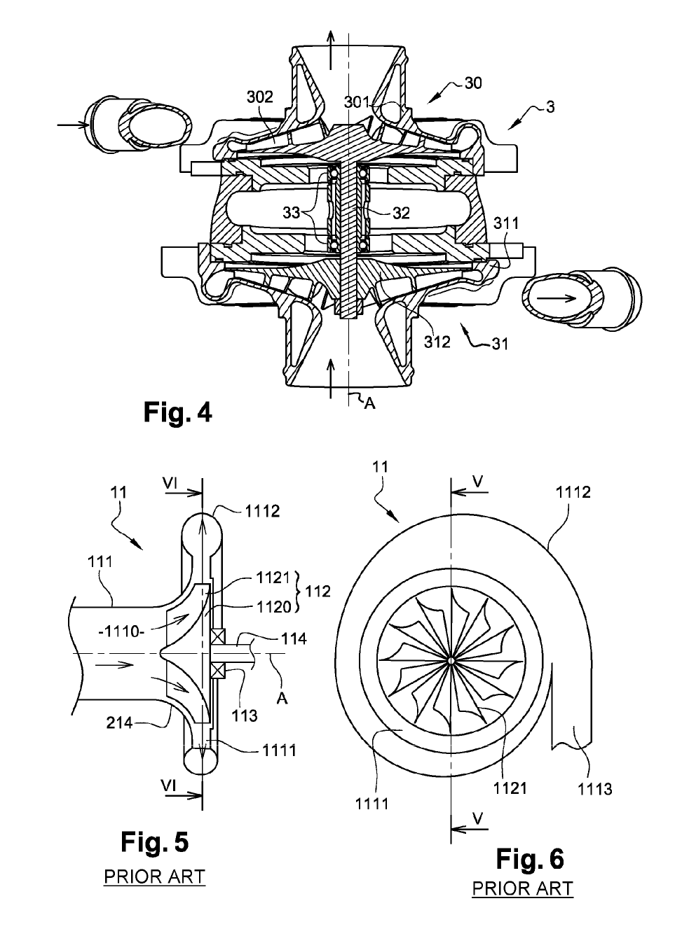

A turbocompressor 3 is shown in FIG. 4 comprising a turbine 30 and a compressor 31 of which the respective rotors 302, 312 are fixed to the same rotating shaft 32 via a bearing 33 placed between the body 311 of the compressor 31 and that of the turbine 301. The rotors 301, 312 are in conformity with the embodiment as described previously. Such a turbocompressor 3 makes it possible to obtain good efficiency for a low gas flow rate. Rotors made in conformity with the invention being particularly large, compared to conventional rotors, this turbocompressor operates at a lower rotation speed of the rotors. For this reason, a bearing 33 can be used with ball bearings.

The invention is not limited to embodiments which have just been described by way of examples. The rotor shaft can be integral with the rotor.

1.-8. (canceled)

9. A rotor for a rotary machine for a fluid, the rotor having an axis of the rotor and comprising a hub arranged to mount the rotating rotor about the axis of the rotor, a flange fixed to the hub and extending substantially in a radial plane with respect to the axis of the rotor, the flange having a front face, blades protruding from the front face, each of the blades extending at most between a central circle and a peripheral circle located on the front face, at least one blade extending to the central circle and at least one blade extending to the peripheral circle, wherein an inner circle and an outer circle are located on the front face between the central circle and the peripheral circle having a difference in diameters of at least 70% of the difference in diameters between the central circle and the peripheral circle, the inner and outer circles belonging to a first circular cone of which the apex is oriented forward and the apex angle whereof is between 154° and 170°, and wherein, no matter what is the circle on the front face located between the inner and outer circles, a second cone having as its axis of revolution the axis of the rotor and the apex whereof is oriented forward, tangent to the front face on the circle, has an apex angle less than or equal to 170°.

10. The rotor according to claim 9, wherein the first cone has an angle of 164°.

11. The rotor according to claim 9, wherein the inner circle and the outer circle have a difference in diameters of at least 85% of the difference in diameters between the central circle and the peripheral circle.

12. The rotor according to claim 9, wherein the blades of a fractional subset of the blades extend toward the periphery from an intermediate circle located between the central circle and the peripheral circle.

13. The rotor according to claim 9, wherein the flange and the hub are integral.

14. A compressor comprising a rotor according to claim 9.

15. A turbine comprising a rotor according to claim 9.

16. A turbocompressor comprising a turbine and a compressor, the turbine and the compressor each having at least one rotor, the rotors being coupled in rotation, wherein at least one of the rotors is a rotor according to claim 9.
